(19) United States
(12) Patent Application Publication
(10) Pub. No.: US 2013/0007581 A1
(43) Pub. Date: Jan. 3, 2013

(54) METHOD AND APPARATUS FOR EDITING COMPOSITE DOCUMENTS

(75) Inventors: George V. Shreck, Springfield, VA (US); Andre Luiz Gomes, Bethesda, MD (US)

(73) Assignee: Landon IP, Inc., Alexandria, VA (US)

(21) Appl. No.: 13/173,849

(22) Filed: Jun. 30, 2011

(51) Int. Cl. G06F 17/00

(52) U.S. Cl. 715/209

(57) ABSTRACT

A gathering, manipulating and analyzing tool for reviewing, displaying and creating reports on composite documents, wherein a composite document is made up of multiple component documents. The present method allows for entry and editing of metadata associated with component documents of the composite document. This allows for more highly refined classifying and bookmarking, which leads to more highly refined searching and displaying abilities. A graphical user interface is provided that allows a user to easily designate multiple sections of the composite document and enter and edit the data and metadata associated with the composite document.

### BACKGROUND OF THE INVENTION

The present invention relates generally to the processing of electronic documents, and more specifically, to a system and method for editing metadata of component documents in order to enhance analysis of an associated composite document.

Most legal transactions have a long and complicated history of documents, whether in digital form or hard copy. Each phase of the transaction is documented and, as negotiations between parties to the transaction progress, the legal terms change and are documented in the document history.

As an example, a patent application is a transaction between the governing authority, such as the United States Patent and Trademark Office (USPTO), and the applicant for the patent. The applicant initiates the transaction, known as “patent prosecution”, by filing an application, which includes a “specification” describing the invention generally and “claims” which define the legal specification of the desired patent protection. Patent application papers are currently submitted to the United States Patent and Trademark Office (USPTO) in paper form (which is then electronically scanned after receipt) or electronically submitted in PDF format via the Electronic Filing System (EFS-Web). Once a patent application is filed with the USPTO, a process begins commonly referred to as the “prosecution of the patent application.”

A patent prosecution is the process by which the applicant (usually a patent attorney representing the inventor) and the patent examiner (a representative of the patent office) engage in a series of arguments and amendments to the patent claims regarding the patentability of the invention. This “back and forth” takes physical form in the official documents submitted by the applicant and the official responses from the patent office. All of the documents exchanged by the applicant and the patent office are collectively referred to as the “patent file history.”

Patent file history papers are eventually presented to the public on the Patent Application Information Retrieval system (PAIR) in Adobe® PDF format as an Image File Wrapper (IFW). Although users of PAIR can select and retrieve file history papers via PAIR, the downloaded file does not have the flexibility of full-text data. The data is essentially trapped in the image of a PDF file, making searching, selecting sections and categorizing impossible. Even if the PAIR images contained searchable hidden text, a user would have to contend with many issues to work with and/or analyze the limited data. Other issues a user of PAIR must deal with are poorly scanned images from the original documents, OCR errors in the hidden text, formatting any text output, and the lack of continuity, or standardization, in submission techniques among thousands of patent practitioners. Thus, PAIR does not provide an adequate tool for analyzing composite documents, such as patent file histories.

Similarly, other transactions, such as merger or acquisition transactions, have long histories of documents that must be reviewed, parsed and analyzed in order to understand the legal specification of the transaction. Further, there are various legal and non-legal documents for which it is desirable to accurately search, review and analyze. It is of course known to record documents in digital form and to search the text electronically, using an index of the documents, in order to find desired words or phrases. While this is an advance over a totally manual method of reading and parsing documents, detailed metadata is still helpful.

Furthermore, databases are well known in the field of computers and computer programs for organizing, displaying and identifying information. Databases allow for structured storage of data, typically in multiple fields. Data in selected fields can then be accessed and displayed in multiple formats. Structured Query Language (SQL) is a computer code specifically designed for accessing selected data from a database. Graphical User Interfaces (GUIs) are also well known in the field. GUIs can be designed for specific computer applications, such as to display information from databases. GUIs can also be general purpose user interfaces, such as a web browser that allows for the display of multiple computer applications. It is also known to add metadata to a document or to database records to facilitate searching. A user can select a document and add metadata through various known user interfaces.

### SUMMARY OF THE INVENTION

A computer implemented method for editing portions of a composite document. The composite document is composed of plural component documents arranged in an ontology, and the component documents are segregated into sections. The method comprises presenting, on a display device, a user interface to an editor of the composite document, the user interface including an instruction field and a section indicator field, and receiving, by a computing device, an editing instruction in the instruction field. The method further comprises receiving, by a computing device, a text entry in the section indicator field, the text entry indicating sections of a component document, and resolving, by a computing device, the text entry into one or more indicated sections of a component document. Next, editing, by a computing device, of each of the one or more indicated sections of the component document is done based on the editing instruction. In an embodiment, the editing instruction is an instruction to add or change metadata, and the step of editing comprises adding or changing metadata of each of the one or more indicated sections of the component document.

The composite document is in some embodiments a patent file history, the component documents include at least one amendment, and the sections are claims within the at least one amendment. In additional embodiments, the step of receiving a text entry may comprise receiving the text of one or more claim numbers. Receiving a text entry may comprise receiving a claim number range indicated by the text of two limiting claims separated by a predefined character. In still further embodiments, the step of receiving an editing instruction comprises receiving an entry of metadata indicating at least one of Claim Data, Original Claim Number, Issued Claim Number, Claim Type, and Claim Dependency. The editing step may comprise at least one of removing blank lines, removing line numbers, removing line breaks, and removing extra blank spaces.

### BRIEF DESCRIPTION OF THE DRAWINGS

FIG. 1 is a block diagram of an exemplary device in accordance with an embodiment;

FIG. 2 is a schematic diagram of the modules in accordance with an embodiment;

FIG. 3 is a representation of a exemplary network connection of the computer of FIG. 1;

FIG. 4 is diagram of an ontology for storing the component documents in one embodiment;

FIG. 5 is a diagram of a user interface in one embodiment describing creating and editing of sections of a component document and other features;

FIG. 6 is a diagram of a user interface in a second embodiment describing creating and editing sections of a component document and other features;

FIG. 7 is a diagram of a user interface describing editing existing claims and other component documents, as well as other features;

FIG. 8 is a diagram of a user interface describing editing claims and other component documents, as well as other features;

FIG. 9 is a flow chart of an embodiment;

FIG. 10(a) is a flow chart of an embodiment;

FIG. 10(b) is a flow chart as a continuation of FIG. 10(a); and,

FIG. 10(c) is a flow chart as a continuation of FIG. 10(b).

### DETAILED DESCRIPTION OF THE INVENTION

What is needed is an analysis tool that provides uniformity in presentation of patent file history data through a method of data organization that allows users to quickly navigate, visualize, analyze and extract data from a patent file history. Distinct data elements of the patent file history, such as documents, claims, remarks and references, would be categorized in a database and presented to end users in an easier format for navigation as opposed to paging and searching through a large PDF file of the patent file history.

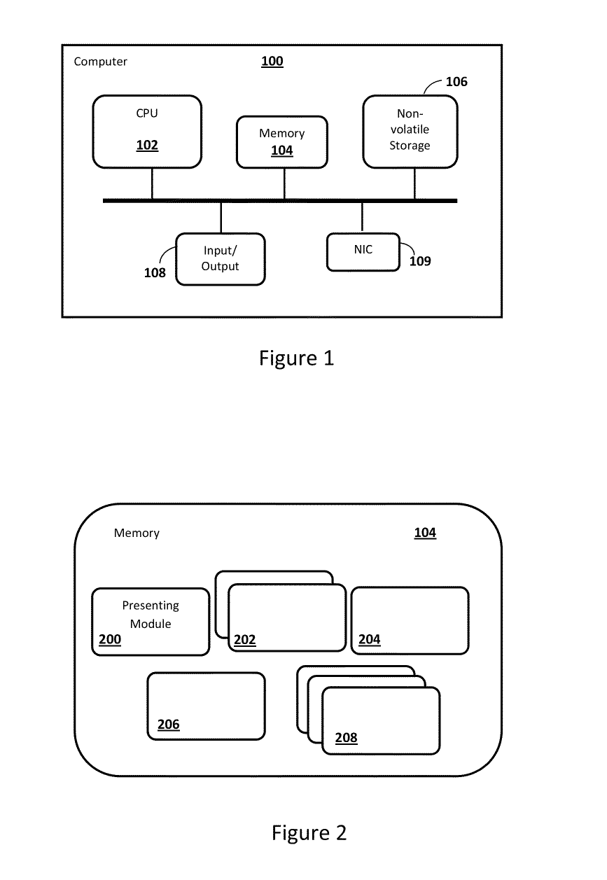

A device, computer 100 is represented in FIG. 1. Computer 100 is at least one Central Processing Unit (CPU) 102, random access memory 104, non-volatile storage device 106, master input/output (I/O) unit 108, and network interface card (NIC) 109. The computer can be any type of general purpose computing device, such as a PC, mobile device, or the like, or combination of one or more such devices. CPU 102 can be any well known, commercially available central processing unit, such as those offered by Intel®, Inc. Random access memory 104 is sufficiently large so as to allow complete loading of modules of the embodiment. Non-volatile storage device 106 allows for storage of all data and instructions required for causing computer 100 to carry out the method. Storage device 106 also provides storage for at least one structured database that is used by the embodiment. Storage device 106 can include multiple storage devices. Master I/O unit 108 accepts input from the user, via a keyboard and a pointing device, such as a computer mouse. Master I/O unit 108 also outputs display screen information for viewing by the user. Network interface card 109 provides computer 100 with access to a network, such as a Local Area Network (LAN) or the Internet.

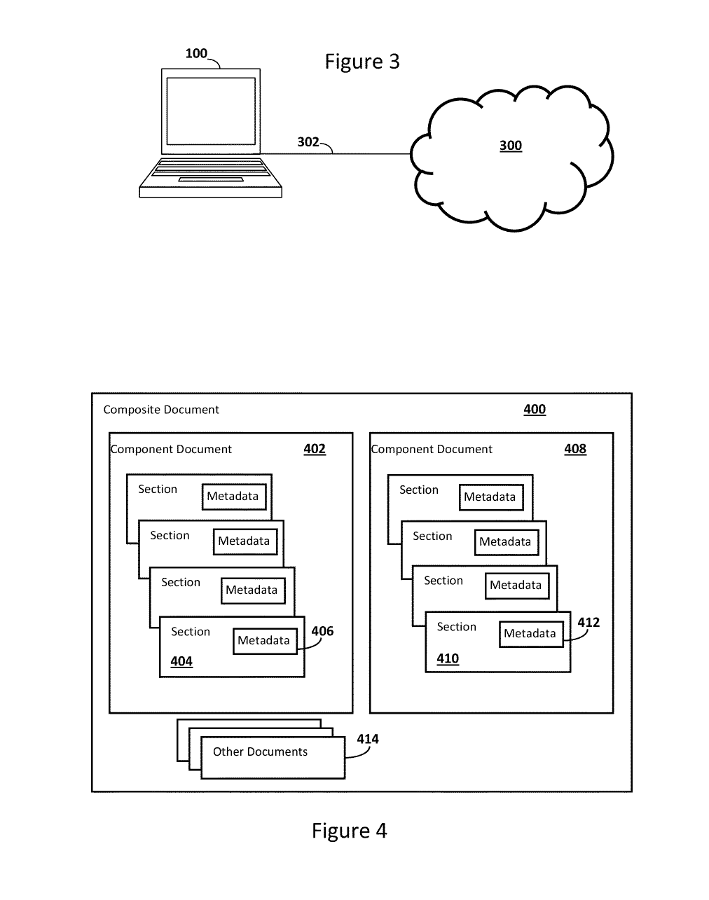

FIG. 2 illustrates random access memory 104 storing all modules of software in a preferred embodiment. The modules comprise computer readable code recorded on a tangible media. Presenting Module 200 presents the graphical user interfaces to the user. The graphical user interfaces, described further below, provide multiple functions and views to the user for analyzing a composite document. The initial GUI includes an instruction field and a section indicator field. Receiving Modules 202 receive editing instructions from the instruction field and text entries from the section indicator field. Resolving Module 204 determines the one or more sections of the component document based on the entered text. Editing Module 206 edits the one or more indicated sections of the component document based on the editing instructions. Other modules 208 provide other functionalities to the invention such as importing and exporting of the documents, files and reports. The disclosed modules are defined and segregated by function for convenience of description. However, the modules need not represent discrete files or sections of code recorded on media. The functions of the modules are described in greater detail below.

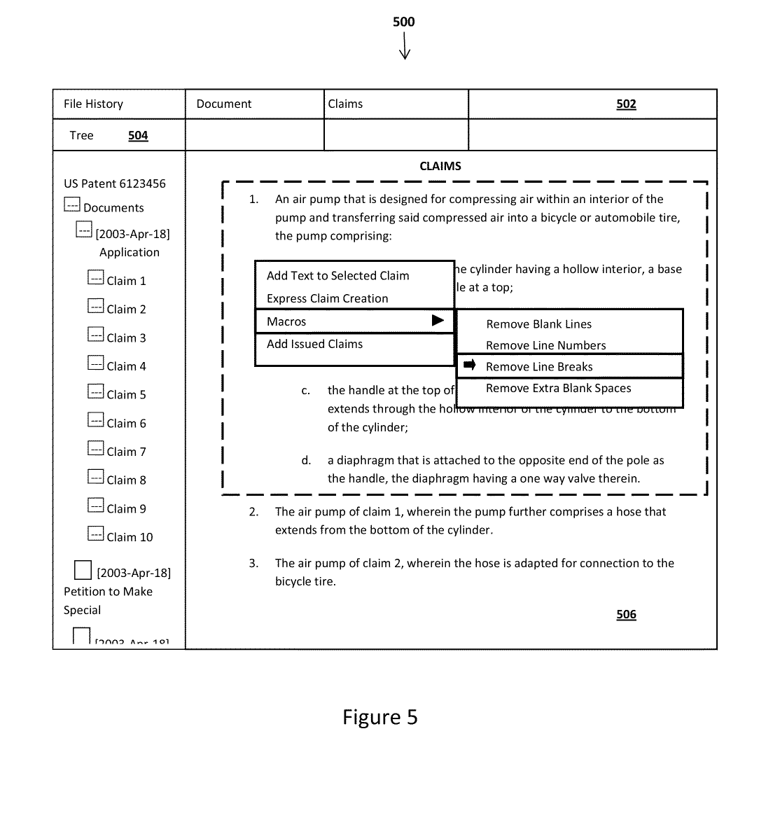

Now referring to FIG. 3, computer 100 is connected to network 300 via connection 302. Connection 302 can be wired or wireless and can use any media and protocols. Network 300 can be the Internet or a LAN that computer 100 uses to connect to the Internet. Once connected to the Internet, computer 100 is able to import publicly available electronic data, including information available on federal government servers such as those that support the U.S. Patent and Trademark Office, the Federal Trade Commission, various Courts, and the Securities and Exchange Commission.

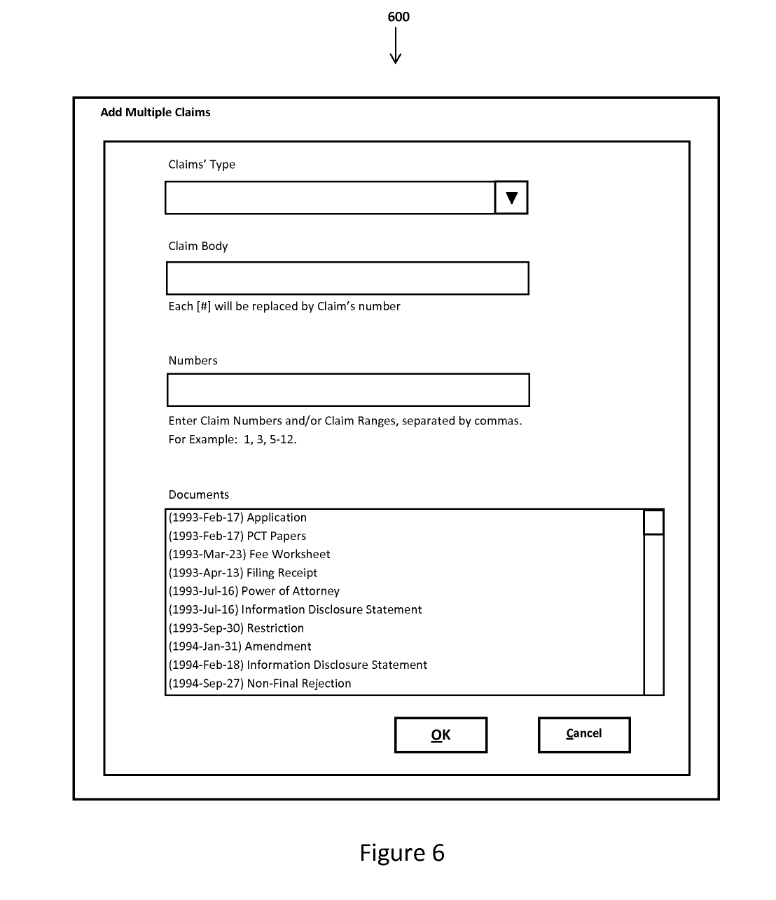

The ontology of a composite document 400 is now considered with reference to FIG. 4. Composite document 400 can be any collection of related documents, images and objects that accumulate over some time period. In the embodiment, each of the accumulated documents are created by, or filed with, a government agency. Composite document 400 in the embodiment is the File History of a U.S. Patent Application. Composite document 400 is composed of multiple component documents 402 & 408. Component documents 402 can be an Amendment, or Amending Document, that changes the language of portions of the Composite Document 400. Component Document 402 comprises multiple Sections 404 and each Section can include Metadata 406. Sections 404 can be a claim that is found in the patent application or issued patent of the File History. A traditional patent application includes a description of the invention, and at least one claim, which defines the legal protection that a resulting patent will provide. Other documents, including the resulting patent and any Certificate(s) of Correction(s) are included in Other Documents 414.

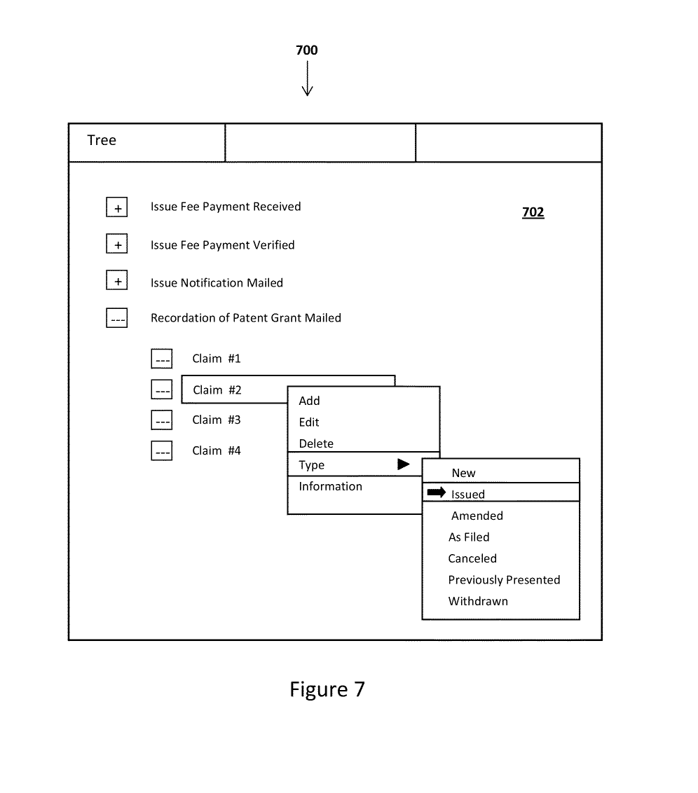

Now in reference to FIG. 5, an exemplary user interface 500 allows for selection of a Component Document and one or more Sections, or claims, of the document. Top row 502 of interface 500 indicates to the user that the Claims of a Document in a File History are being displayed and may also serve as a workspace for claims. First column 504 in interface 500 indicates the documents and claims that are available for selection displayed in a Tree format. Main window 506 of interface 500 displays desired claims, or Sections, and shows that Claim 1 has been selected for editing. As shown in FIG. 5, the user has the options to: Add Text to a Claim on the Tree; Add Multiple Claims to a Component Document (Express a Claim Creation); use a selected Macro; and, add Issued Claims to the Component Document. In FIG. 5, the user has selected to use one of the available Macros to Remove Line Breaks from the claim. Macros are used to format the text before linking to a Composite Document or Section of the Document. Other Macros available to the user include: Remove Blank Lines; Remove Line Numbers; and, Remove Extra Blank Spaces.

While limited, patent file history papers are eventually made available to the public on the USPTO's Patent Application Information Retrieval (PAIR) system. The PAIR system suffers many drawbacks and disadvantages, for example the prosecution data itself does not have the flexibility of full-text data. The data is essentially trapped in the image of a PDF file. The present embodiment provides a method of data entry that allows users to create a composite document that can be quickly navigated, visualized, analyzed and from which data can be extracted. Distinct data elements of the composite document, such as documents, claims, remarks and references, are categorized in a database and presented to end users in an easier format for navigation as opposed to paging and searching through a large PDF file.

Additionally, the fact that the categorized data elements are stored in a database allows users to easily cross-reference data elements, for example, users will be able to easily call a presentation of all claims iterations at once, instead of needing to find claims in multiple places somewhere in the large patent file history.

An embodiment includes a process to gather the necessary documents which make up the subject patent file history. This process can involve manually photocopying the paper file history and then scanning or downloading the patent file history. After gathering all documents to the patent file history, the file is processed using optical character recognition (OCR) technology. The output files from the OCR process are verified and corrected, and the file is bookmarked. Using the verified and bookmarked file, patent file history data is systematically entered into the database as a composite document.

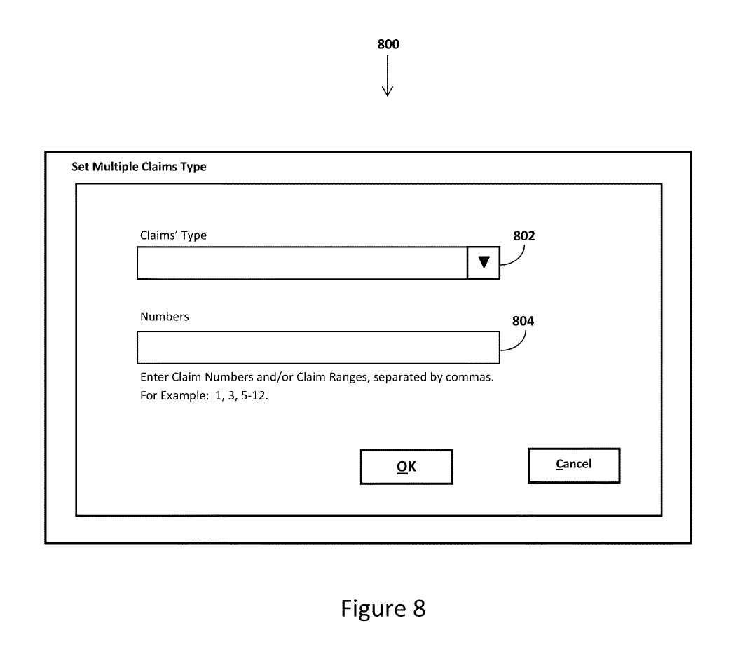

Another user interface 600 for creating and editing claims, or Sections of a Component Document is now described in reference to FIG. 6. The data entry process is as follows: metadata regarding the patent file is entered, including File Type (US, PAP, USSN) via a dropdown menu. Metadata regarding the patent file is entered, including File Number via a text box. The amount of characters in the File Number must conform to the File Type selected. After the patent file data is entered, metadata for each document in the file history is entered by use of an import functionality. Document data such as Date, Title and bookmarks are captured during the import process. Additionally, Document data such as Document Type, Description and Notes are captured via menus available on the GUI.

After document data is entered, metadata for each claim iteration found in the patent file history is entered. Metadata regarding the Original Claim number is entered via a text box. Metadata regarding the Issued Claim number (if applicable) is entered via a text box. Metadata for multiple claims regarding Claim Type is entered via a dropdown menu, via interface 600. Metadata regarding Claim Dependency (if an Issued Claim) is entered via a check box indicating Dependency. The Parent Claim data (if Dependent) is entered via a text box. Metadata regarding the text of the Claim is entered via a text box.

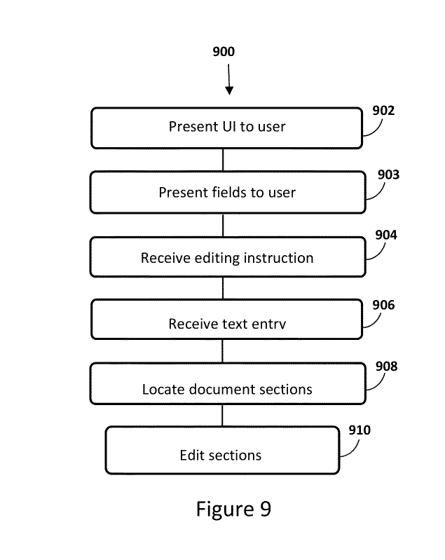

An exemplary user interface 700 for editing the metadata of existing claims is now described in reference to FIG. 7. In main window 702 the user has selected Claim #2 from a Granted Patent and is editing the “Type” so as to change the type of claim to that of Issued, meaning the Claim is in force in a Patent, and may be legally upheld in a court. Interface 700 also allows the user to change the “Type” of a claim to: New; Amended; As Filed; Canceled; Previously Presented; and, Withdrawn. Using interface 700, the user may also Add, Edit, Delete, and get more Information regarding any selected claim.

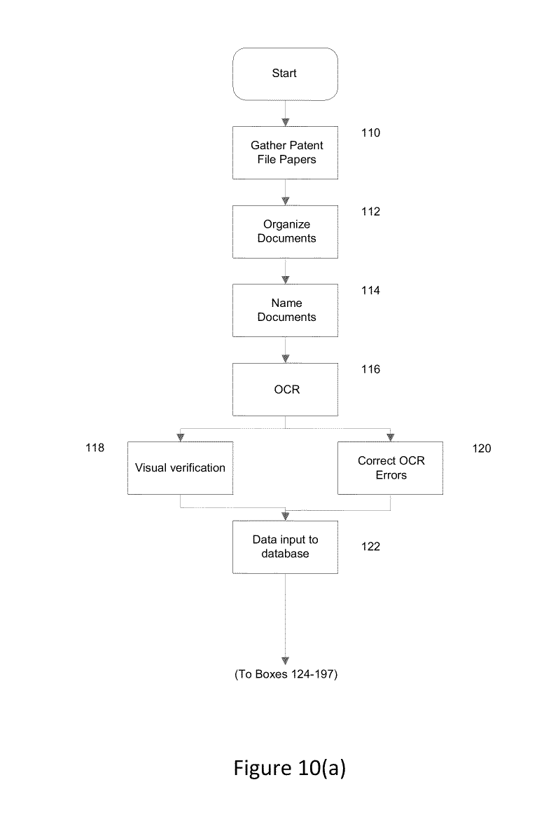

A graphical user interface 800 for editing existing claims is presented in FIG. 8. Interface 800 allows for easy entry of metadata by allowing the user to enter a “Type”, or other metadata, for multiple claims all at once. Drop down menu 802 allows the user to select the appropriate “Type”, such as New, Canceled or Issued, to be associated with a group of claims, i.e., sections. Entry window 804 allows for text entry of a single claim, a range of claims, or single claims and a range of claims. After the “Type” has been selected and the desired claim numbers have been entered, the user can click on the “OK” button at the bottom of the interface 800. Interfaces such as those shown in FIGS. 5-8 allow entry and editing of data and metadata associated with the claims, or sections, of a component document. This manipulation of data, especially of the metadata, allows the present embodiment to provide unmatched functionality when it comes to creating composite documents. Text is entered into entry window 804. For example, a user can enter “1-3”. Resolving Module 204 receives the text entry and resolves the text entry into one or more claims using rules or the like. In this example, resolving module 204 resolves “1-3” into claim 1, claim 2, and claim 3. All metadata changes indicated by drop down menu 802 are applied to all resolved claims.

After data entry, a validation process may be performed to validate that the data elements existing in the file are complete and linked properly. Validation rules include File, Document and Claim validation. Regarding File validation: every File must have a Number; if a Patent, the Number must be 7 digits; if a Published Application (PAP), the Number must be 11 digits; if a US Serial Number (Application), the Number must be 8 digits; and every File must have a Type (Patent, PAP, or Application). Every Patent file requires issued claims. PAP or Application files do not require issued claims. Regarding Document validation: every Document included in a Timeline needs a Type; every Document needs a Date; the Document Date must be before today's date; every Document needs a Title; each Document must have a unique Title and Date combination. More than one claim with the same Original Number in the same Document is not allowed. More than one claim with the same Issued Number in the same Document is not allowed. Regarding Claim Validation: all claims must have an Original Number; all issued claims must have an Issued Number; all claims must have a Type; only issued claims may be dependent with parent indication; issued claims indicated as dependent require a parent claim number; issued claims that show a parent claim number must be checked as dependent; at the Claim Level, fields for Original, Issued or parent claim, cannot have a “0” (zero) entered as a number; and, all claims must have text.

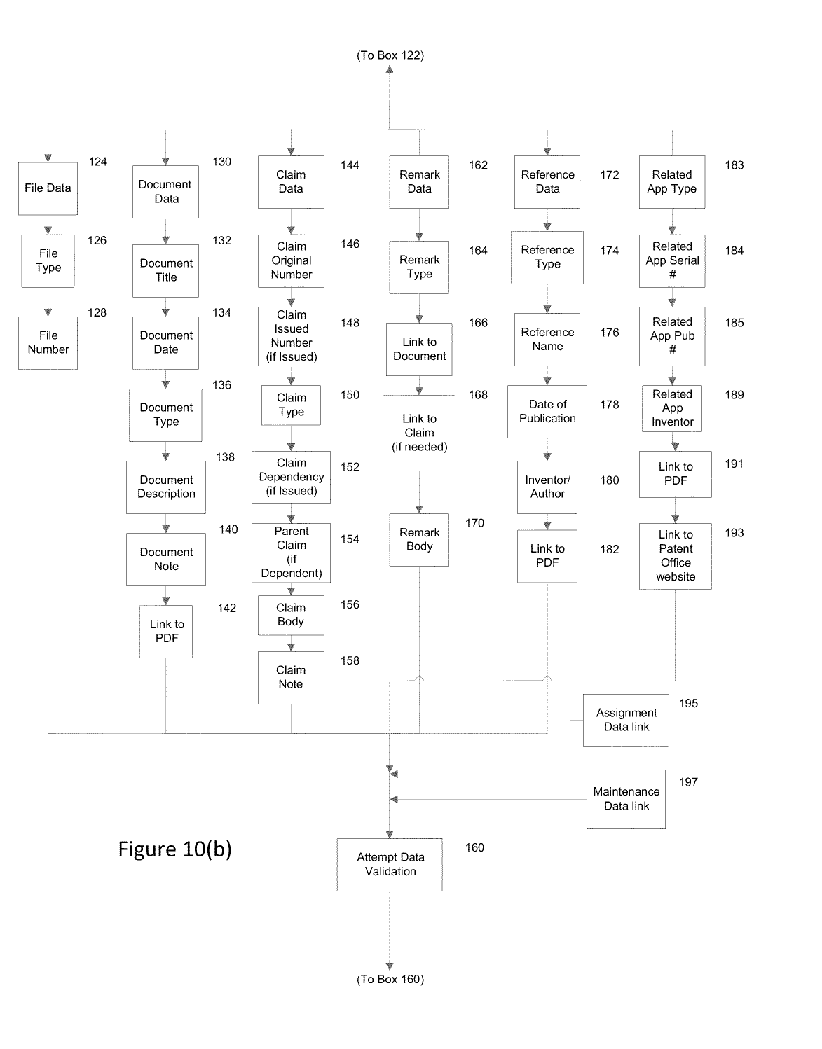

FIG. 9 is a flow chart 900 showing exemplary steps in the present method. In step 902 the user is presented with an Editor Interface for editing Composite Documents, such as the file history of a patent. In step 903, an Instruction field, such as drop down menu 802, and a Section Indicator field, such as entry window 804, are presented to the user. In step 904, an editing instruction is received in the Instruction field, from the user. The editing instruction relates to editing data and/or metadata within the Composite Document. In step 906, a text entry is received in the Section Indicator field. The Section Indicator, in the present example, indicates which claim or claims will be affected by the editing instruction. In step 908, the present method finds the appropriate Sections within the appropriate Component Document for editing. In step 910, the Sections of the Component Document are edited in accordance with the Editing Instructions. Editing of the Sections, or claims, includes editing of data and metadata within the Sections.

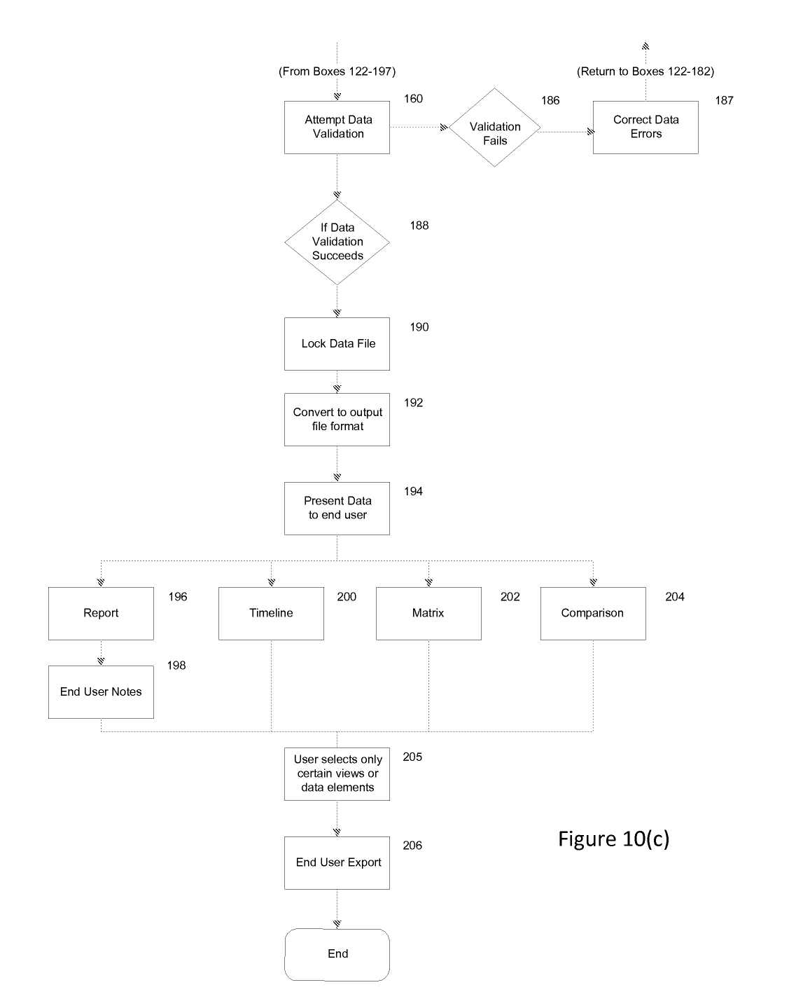

FIGS. 10(a)-(c) show a more detailed flow chart of the present method, using a patent file history as the exemplary composite document.

The following numbering system applies to the flow charts of FIGS. 10(a)-(c).

### Element 110—Gather File Papers

### Element 112—Organize Documents

### Element 114—Name Documents

### Element 116—OCR

Element 118—Visual verification

### Element 120—Correct OCR Errors

Element 122—Date input to database

### Element 124—File Data

### Element 126—File Type

### Element 128—File Number

### Element 130—Document Data

### Element 132—Document Title

### Element 134—Document Date

### Element 136—Document Type

### Element 138—Document Description

### Element 140—Document Note

### Element 142—Subsections

### Element 144—Claim Data

### Element 146—Claim Original Number

### Element 148—Claim Issued Number (if Issued)

### Element 150—Claim Type

### Element 152—Claim Dependency (if Issued)

### Element 154—Parent Claim (if Dependent)

### Element 156—Claim Body

### Element 158—Claim Note

Element 160—Attempt Data Validation (from data in Elements 122-182)

### Element 162—Remark Data

### Element 164—Remark Type

### Element 166—Link to Document

Element 168—Link to Claim (if needed)

### Element 170—Remark Body

### Element 172—Reference Data

### Element 174—Reference Type

### Element 176—Reference Name

### Element 178—Date of Publication

### Element 180—Inventor/Author

### Element 182—Link to PDF

### Element 183—Related Application Type

Element 184—Related Application Serial number
Element 185—Related Application Publication number

### Element 186—If Data Validation Fails

Element 187—Correct Data Errors (in data found in Elements 122-182)

### Element 188—If Data Validation Succeeds

### Element 189—Related Application Inventor

Element 190—Lock file
Element 191—Related Application link to PDF
Element 192—Convert to output file format
Element 193—Related Application link to patent office website
Element 194—Present Data to end user
Element 195—Assignment data link

### Element 196—Report

Element 197—Maintenance fee data link

### Element 198—End User Notes

### Element 200—Timeline

### Element 202—Matrix

### Element 204—Comparison

Element 205—User selects only certain views or data elements

### Element 206—End User Export

After starting the exemplary process, patent file history papers are gathered in step 110, the documents are organized in step 112, and named according to a naming scheme in step 114. The documents are OCR'd in step 116, and verified for correctness in steps 118 and 120. In step 122, the electronic data is input into a database. Once in the database, the file history documents, data, and metadata can be edited using the present graphical user interface, steps 124-158. The present method also allows users to add remarks and link reference and other information to a composite document, steps 162-193. The user is allowed to add Assignment and Maintenance fee data in steps 195 & 197. In step 160, Validation of the Data is attempted. Correcting any errors found during Validation occurs in steps 186-188. In step 190, the file history has passed Validation and the data is locked. In step 192, the file format is converted to an output format, and made available to users in step 194. Steps 196-204 allow for display of information in the file history in multiple different views, including Timeline, Matrix and Comparison. In step 205, the user selects the views and/or data elements he wants included in a report. In step 206, the user exports his report, and the process Ends.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the invention as defined by the appended claims. It is to be understood that the phraseology of terminology employed herein is for the purpose of description and not of limitation.

I claim:

1. A computer implemented method for editing portions of a composite document, the composite document being composed of plural component documents arranged in an ontology, the component documents being segregated into sections, the method comprising:
presenting, on a display device, a user interface to an editor of the composite document, the user interface including an instruction field and a section indicator field;
receiving, by a computing device, an editing instruction in an instruction field;
receiving, by a computing device, a text entry in the section indicator field, the text entry indicating sections of a component document;
resolving, by a computing device, the text entry into one or more indicated sections of a component document; and
editing, by a computing device, each of the one or more indicated sections of the component document based on the editing instruction.

2. The method of claim 1, wherein the editing instruction is an instruction to add or change metadata and wherein said step of editing comprises adding or changing metadata of each of the one or more indicated sections of the component document.

3. The method of claim 2, wherein the composite document is a patent file history, the component documents include at least one amendment, and the sections are claims within the at least amendment.

4. The method of claim 3, wherein said step of receiving a text entry comprises receiving the text of one or more claim numbers.

5. The method of claim 2, wherein said step of receiving a text entry comprises receiving a claim number range indicated by the text of two limiting claims separated by a predefined character.

6. The method of claim 3, wherein said step of receiving an editing instruction comprises receiving an entry of metadata indicating at least one of claim Data, Original claim Number, Issued claim Number, Claim Type, and claim Dependency.

7. The method of claim 1, wherein said editing step comprises at least one of removing blank lines, removing line numbers, removing line breaks, and removing extra blank spaces.

8. A computer system for editing portions of a composite document, the composite document being composed of plural component documents arranged in an ontology, the component documents being segregated into sections, the system comprising:
at least one processor; and
a memory device operatively coupled to the at least one processor and storing computer executable instructions which, when executed by the at least one processor, cause the at least one processor to carry out the method comprising:
presenting a user interface to an editor of the composite document, the user interface including an instruction field and a section indicator field;
receiving an editing instruction in an instruction field;
receiving a text entry in the section indicator field, the text entry indicating sections of a component document;
resolving the text entry into one or more indicated sections of a component document; and
editing each of the one or more indicated sections of the component document based on the editing instruction.

9. The system of claim 8, wherein the editing instruction is an instruction to add or change metadata and wherein said step of editing comprises adding or changing metadata of each of the one or more indicated sections of the component document.

10. The system of claim 9, wherein the composite document is a patent file history, the component documents include at least one Amendment, and the sections are claims within the at least amendment.

11. The system of claim 10, wherein said step of receiving a text entry comprises receiving the text of one or more claim numbers.

12. The method of claim 9, wherein said step of receiving a text entry comprises receiving a claim number range indicated by the text of two limiting claims separated by a predefined character.

13. The method of claim 10, wherein said step of receiving an editing instruction comprises receiving an entry of metadata indicating at least one of claim Data, Original claim Number, Issued claim Number, claim Type, and claim Dependency.

14. The method of claim 8, wherein said editing step comprises at least one of removing blank lines, removing line numbers, removing line breaks, and removing extra blank spaces.

15. Computer readable media storing computer executable instructions which, when executed by the at least one processor, cause the at least one processor to carry out a method for editing portions of a composite document, the composite document being composed of plural component documents arranged in an ontology, the component documents being segregated into sections, the method comprising:
presenting a user interface to an editor of the composite document, the user interface including an instruction field and a section indicator field;
receiving an editing instruction in an instruction field;
receiving a text entry in the section indicator field, the text entry indicating sections of a component document;
resolving the text entry into one or more indicated sections of a component document; and
editing each of the one or more indicated sections of the component document based on the editing instruction.

16. The media of claim 15, wherein the editing instruction is an instruction to add or change metadata and wherein said step of editing comprises adding or changing metadata of each of the one or more indicated sections of the component document.

17. The media of claim 16, wherein the composite document is a patent file history, the component documents include at least one Amendment, and the sections are claims within the at least amendment.

18. The media of claim 17, wherein said step of receiving a text entry comprises receiving the text of one or more claim numbers.

19. The media of claim 16, wherein said step of receiving a text entry comprises receiving a claim number range indicated by the text of two limiting claims separated by a predefined character.

20. The media of claim 17, wherein said step of receiving an editing instruction comprises receiving an entry of metadata indicating at least one of claim Data, Original claim Number, Issued claim Number, claim Type, and claim Dependency.

21. The media of claim 15, wherein said editing step comprises at least one of removing blank lines, removing line numbers, removing line breaks, and removing extra blank spaces.

22. The method of claim 2, wherein said step of editing comprises adding or changing metadata associating each of the one or more indicated sections with selected component documents.

23. The system of claim 9, wherein said step of editing comprises adding or changing metadata associating each of the one or more indicated sections with selected component documents.

24. The media of claim 16, wherein said step of editing comprises adding or changing metadata associating each of the one or more indicated sections with selected component documents.
